(19) United States
(12) Patent Application Publication
(10) Pub. No.: US 2008/0259932 A1
(43) Pub. Date: Oct. 23, 2008

(54) Method and System for Facilitating a First and Second Protocol Between a Data Processing System and an ISP

(75) Inventors: Glen Gabriel, Gilroy, CA (US); Michael Hightower, San Jose, CA (US)

Correspondence Address: STAAS & HALSEY LLP, SUITE 700, 1201 NEW YORK AVENUE, N.W., WASHINGTON, DC, 20005, US

(73) Assignee: SIEMENS HOME AND OFFICE COMMUNICATION DEVICES GMBH & CO. KG, MUNICH (DE)

(21) Appl. No.: 11/629,903

(22) PCT Filed: Jun. 3, 2005
(86) PCT No.: PCT/EP05/52551

§ 371 Date: Jan. 18, 2008

Related U.S. Application Data
(60) Provisional application No. 60/580,835, filed on Jun. 18, 2004.

(51) Int. Cl. H04L 12/56; G06F 15/16

(52) U.S. Cl. 370/395.5; 709/228

(57) ABSTRACT

An access unit (25) for configuring a first and second network-layer protocol for use over the point-to-point link and to facilitate communication between an Internet Service Provider (ISP) (20) and a data processing system (12) over the link. The data processing system (12) includes a first 28(1) and second protocol stack 28(2). The access unit (25) includes a multi-protocol (32) driver for routing a packet received from the ISP (20), a Wide Area Network (WAN) access driver (24) adapted to monitor an establishment of the link connection to capture a maximum receive unit, and a converter (23) adapted to receive a trigger from the WAN access driver (24), the trigger for indicating to the converter (23) to configure the second network-layer protocol on the link.

### FIELD OF THE INVENTION

The present invention relates to the field of communication systems, and more particularly to a method and system for facilitating a first and second protocol between a data processing system and an Internet Service Provider.

### BACKGROUND

Communication protocols facilitate communication between a data processing system, such as a home computer, and a communication network such as the Internet. Different protocols as well as different versions of the same protocol are created as the network evolves. In some cases newer versions of a protocol are not backwards compatible with a previous version. For example Internet Protocol (IP) version 6 has a different header than version 4 and therefore is not compatible.

A user of a data processing system may want to access the network using more than one protocol or more than one protocol version. This is a problem in operating systems that are not provisioned or partially provisioned to handle a variety of protocols and/or protocol versions. Therefore, there is a need for a method and system to facilitate access to the network using different protocols and/or protocol versions.

### SUMMARY OF THE INVENTION

The present invention recognizes a need for a method and system to provide a configuration and communication of a point-to-point link between a data processing system and an Internet Service Provider (ISP) for a first and second network-layer protocol wherein the data processing system has a mechanism, such as a dialer, to configure and communicate using a first network-layer protocol. However, the data processing system does not have a mechanism to configure and communicate using the second network-layer protocol. An access unit may for example, monitor the link establishment and first network-layer protocol configuration provided by the dialer and the access unit configure the second network-layer protocol after the completion of the configuration of the first network-layer protocol.

In one aspect of the invention, a method of establishing a point-to-point link between a data processing system and an ISP and of configuring a first and second network-layer protocol for use over the link, the data processing system having a dialer, and a first and second protocol stack. The method comprising monitoring, by an access unit, the establishment of the link connection to determine a negotiated value. The method further comprising monitoring, by the access unit, the first network-layer protocol configuration for the completion of the configuration and configuring, by the access unit, the link for the second network-layer protocol after the completion of the first-network layer protocol configuration.

In another aspect of the invention, a method of communication between an ISP and a data processing system, the data processing system having a first protocol stack handling a first network-layer protocol, and second protocol stack handling a second network-layer protocol. The method comprising receiving a first packet having a first network-layer protocol packet encapsulated in a data-link-layer protocol, routing the first packet toward a Wide Area Network (WAN) interface, receiving a second packet having a second network-layer protocol packet encapsulated in the data-link-layer protocol, and converting the second packet to remove the data-link-layer protocol and sending the converted packet to the second protocol stack.

In still another aspect of the invention, an access unit for configuring a first and second network-layer protocol for use over the point-to-point link and to facilitate communication between an ISP and a data processing system over the link, the data processing system including a first and second protocol stack, the access unit comprising a multi-protocol driver for routing a packet received from the ISP, a WAN access driver adapted to monitor an establishment of the link connection to capture a maximum receive unit and a converter adapted to receive a trigger from the WAN access driver, the trigger for indicating to the converter to configure the second network-layer protocol on the link.

### BRIEF DESCRIPTION OF THE DRAWINGS

The above mentioned and other concepts of the present invention will now be described with reference to the drawings of the exemplary and preferred embodiments of the present invention. The illustrated embodiments are intended to illustrate, but not to limit the invention. The drawings contain the following figures, in which like numbers refer to like parts throughout the description and drawings wherein:

FIG. 1 illustrates an exemplary prior art communication system that is suitable for use with methods and systems consistent with the present invention.

FIG. 2 illustrates an exemplary communication setup consistent with the present invention.

FIG. 3 illustrates an exemplary data processing system consistent with the present invention.

### DETAILED DESCRIPTION OF THE INVENTION

The present invention is disclosed in context of communicating between a data processing system and the Internet using two versions of an Internet Protocol (IP) version 4 (IPv4) and IP version 6 (IPv6), and using a Point-to-Point Protocol (PPP) over Ethernet (PPPoE). The invention may, however, be embodied in many different forms and may be applied to many different types of networks, protocols, and protocol versions and should not be construed as limited to the embodiments set forth herein. Rather, these embodiments are provided so that this disclosure will be thorough and complete, and will fully convey the scope of the invention to those skilled in the art. Thus, the scope of the invention should be determined based upon the appended claims and their legal equivalents, rather than the specific embodiments described below.

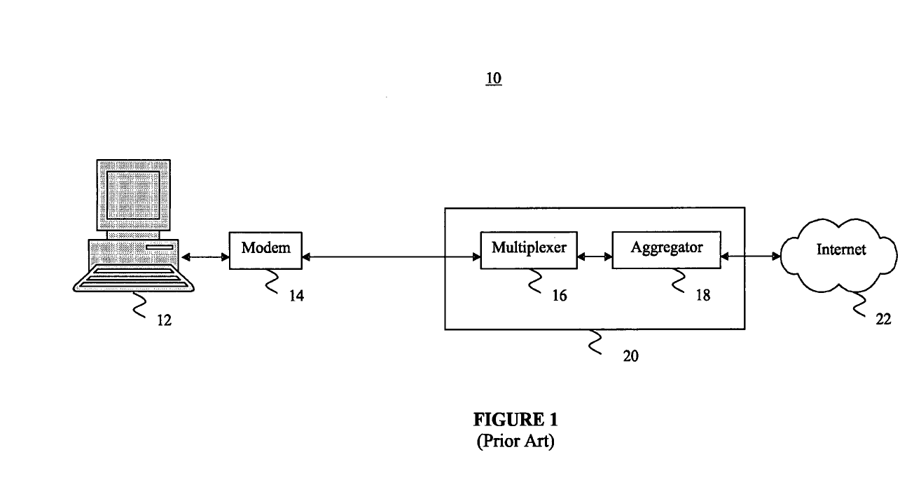

Referring to prior art FIG. 1, an exemplary communication system 10 providing a PPP communication link between a data processing system 12 and an Internet 22 is shown. Communication system 10 includes a modem 14 to operatively connect the data processing system 12 to an Internet Service Provider (ISP) 20. The ISP 20 includes a mulitplexer 16 and aggregator 18 to facilitate the communication between the ISP 20 and the Internet 22. The term “communication link” refers herein to any suitable wireless and/or wireline, electrical and/or optical based system that supports communication between network elements using ground-based and/or space-based components. Herein, the terms “operatively connect”, “operatively connects”, and “operatively connected” refer to any direct or indirect communication between two or more elements in the communication system 10, whether or not those elements are in physical contact with one another.

A modem 14 operatively connects the data processing system 12 to the ISP 20. The modem 14 may be a hardware device, software unit or combination thereof for modulating signals for transmission over a transmission medium to a remote site and demodulating signals received through the medium from a remote site such as the ISP 20. The term “software unit” refers herein to any configuration of software such as a method, module, function, thread, executable, application or any other suitable configuration of software code.

In an exemplary configuration, the ISP 20 includes a multiplexer 16 that is operatively connected to an aggregator 18. The multiplexer 16 allows many transmission medium connections to a single access in the ISP 20. The aggregator 18, such as a network access server, facilitates transmission of the transmission mediums from the multiplexer 16 to and from the Internet 22.

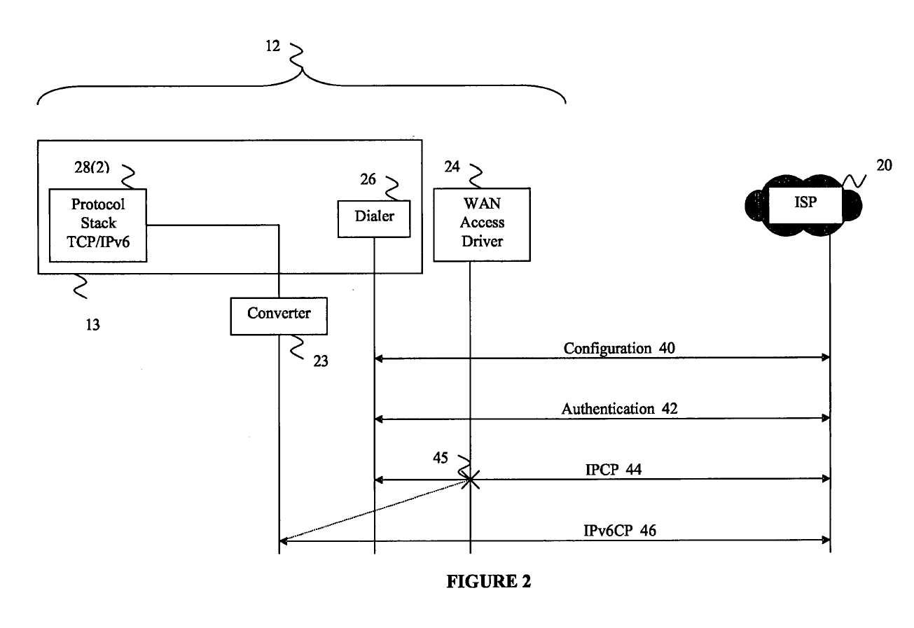

Referring now to FIG. 2, a point-to-point communication negotiation between the data processing system 12 and the ISP 20 via operational phases of PPP according to one embodiment of the present invention is shown. Operational phases of PPP may include link establishment, authentication and network-layer protocol. The operational phases are illustrated in FIG. 2 by the simplified flows, configuration 40, authentication 42, IP Control Protocol for IPv4 (IPCP) 44, and IP Control Protocol for Ipv6 (IPv6CP) 46. The data processing system 12 includes a second protocol stack 28(2) in operatively connected with a converter 23, an Operating System (OS) 13 comprising a dialer 26, and a Wide Area Network (WAN) access driver 24. The WAN access driver 24 includes a trigger mechanism.

PPP runs on a full-duplex link, for example, Digital Subscriber Line (DSL), Plain Old Telephone Service (POTS), Integrated Services Digital Network (ISDN), and Ti. PPP provides a method for encapsulating packets over point-to-point links. PPP also establishes, configures, and tests a data-link connection via a Link Control Protocol (LCP). Additionally, PPP includes a family of Network Control Protocols (NCPs) for establishing and configuring different network-layer protocols. PPP is an example of a data link layer (layer 2) in an Open Systems Interconnection (OSI) model. The term “protocols” refers herein to different protocols and/or different protocol versions.

The operating system 13 manages the software units provided by the data processing system 12. Additionally, the operating system may provide a dialer 26, a protocol stack 28, or combinations thereof. However, the dialer 26, the protocol stack 28, and combinations thereof may be provided by a source other than the operating system, as would be understood by those skilled in the art.

In the illustrated embodiment, the dialer 26 handles the link establishment phase, an authentication phase, and a network-layer protocol phase for IPv4. The dialer 26 may be a hardware device, software unit, or combinations thereof. A mechanism other than the dialer 26 may also be used to handle these phases.

### Link Establishment Phase

Still referring to FIG. 2, the PPP link connection is established during the link establishment phase via the LCP. The link establishment phase includes sending LCP configuration packets 40 between the data processing system 12 and the ISP 20. During the link establishment phase, configuration options independent of particular network-layer protocols are configured. For example, an LCP field, maximum receive unit (MRU), configures the maximum frame size that can be received.

In a preferred embodiment, a WAN access driver 24 monitors the LCP configuration packets 40, and captures the MRU field from the ISP 20 and the MRU field from data processing system 12. Both MRU values are compared and the smaller of two values is made available to a converter 23 for later use as described in more detail below. The WAN access driver 24 may be a hardware device, software unit or combinations thereof.

### Authentication Phase

Still referring to FIG. 2, an authentication phase provides an authentication between the data processing system 12 and the ISP 20. The authentication phase includes sending authentication packets 42 between the data processing system 12 and the ISP 20 using a protocol that was negotiated during the link establishment phase.

### Network-Layer Protocol Phase

Still referring to FIG. 2, a protocol to be transmitted on the link may be configured during the network-layer protocol phase. In the exemplary embodiment illustrated in FIG. 2, IPv4 and IPv6 are configured. The configuration of the IPv4 network-layer protocol includes sending IPCP frames 44 between data processing system 12 and the ISP 20.

In one embodiment of the present invention, the trigger mechanism 45 triggers a converter 23 to handle the network-layer protocol phase for IPv6. In a preferred embodiment the trigger 45 occurs after completing configuration of the IPv4 network-layer protocol. Other triggers, such as the completion of the authentication phase, may also be used.

In one embodiment of the present invention, the converter 23 is triggered to handle the network-layer protocol phase for IPv6. The converter 23 may be hardware, software unit, or combinations thereof. The network-layer link phase for IPv6 includes sending IPv6CP frames 46 between the data processing system 12 and the ISP 20. Additionally, the converter 23 may configure a Maximum Transmission Unit (MTU) used by a second protocol stack 28(2). The MTU is the maximum packet that the second protocol stack 28(2) is capable of transmitting. The MTU is advantageously configured to be less than or equal to the smaller MRU value. Details of the MTU configuration are described further below.

As would be understood by those skilled in the art, not all of the above phases are required. Also, it is possible to include additional phases.

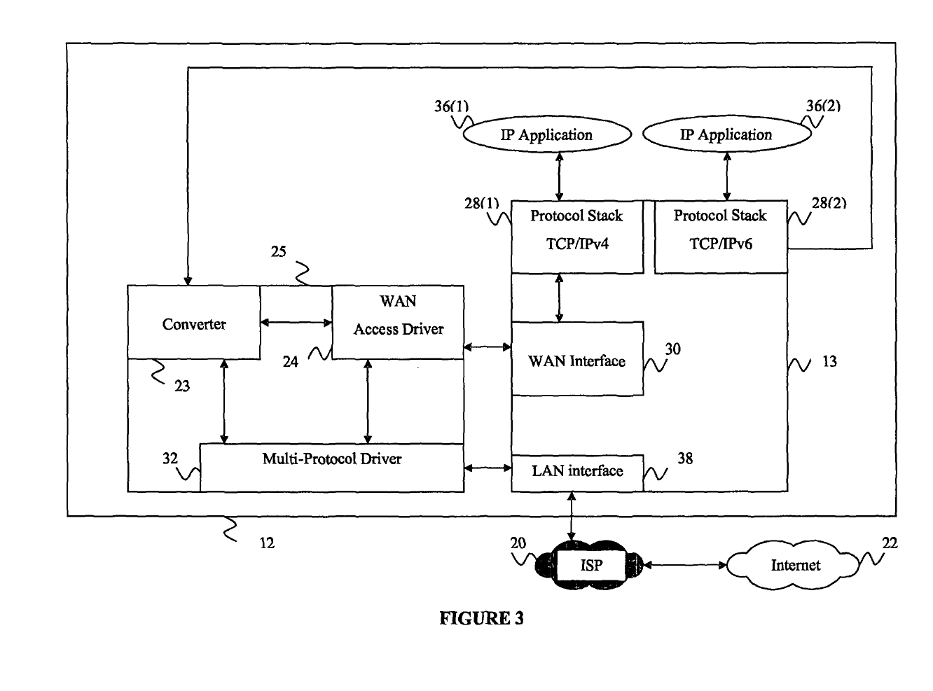

FIG. 3 illustrates an exemplary embodiment of the data processing system 12 operatively connected with the ISP 20 in accordance with one embodiment of the present invention. Data processing system 12 includes a first IP application 36(1), a second IP application 36(2), the operating system 13 that comprises the WAN interface 30, a Local Area Network (LAN) interface 38, a first protocol stack 28(1), and the second protocol stack 28(2) and an access unit 25 that comprises a WAN access driver 24, the converter 23 and a multi-protocol driver 32. The first IP application 36(1) is operatively connected with the ISP 20 via a first protocol stack 28(1) for the purpose of communicating IPv4 packets to the Internet 22. The WAN interface 30 is operatively connected with the first protocol stack 28(1), and the WAN access driver 24. The WAN access driver 24 also operatively connected to the converter 23 and a multi-protocol driver 32. The LAN interface 38 operatively connected to the multi-protocol driver and the ISP 20. A second IP application 36(2) operatively connected with the ISP 20 via the second protocol stack 28(2) for the purpose of communicating IPv6 packets to the Internet 22. The second protocol stack 28(2) operatively connected to the converter 23. The converter 23 also operatively connected to the multi-protocol driver 32.

The first IP application 36(1) may be a web browser or any other application that requests access to the Internet 22. Although only one first IP application 36(1) is shown to interface with the first IP protocol stack 28(1), multiple first IP applications 36(1) may interface with the first IP protocol stack 28(1).

The operating system 13 may provide a WAN interface 30, a LAN interface 38, or combinations thereof. However, the WAN interface 30, the LAN interface 38, and combinations thereof may be provided by a source other than the operating system, as would be understood by those skilled in the art.

The first protocol stack 28(1) provides Transmission Control Protocol (TCP) processing for IPv4 (TCP/IPv4). A protocol stack may be a hardware device, software unit or combination thereof for providing interfaces, such as an application program interface (API), to facilitate the processing of a protocol. TCP is a connection oriented transport mechanism that provides a reliable transmission. TCP resides at the transport layer (layer 4) of the OSI model. The first protocol stack 28(1) converts the data communicated from the first IP application 36(1) to TCP/IPv4 packets and sends the packets to the WAN interface 30.

The WAN interface 30 may be a hardware device, software unit or combination thereof for providing an interface between a network interface card (NIC) and the first protocol stack 28(1). For example, the WAN interface 30 may be a Network Driver Interface Specification (NDIS) miniport driver, a NDIS legacy driver, and the like. When receiving a packet from the first protocol stack 28(1), the WAN interface 30 facilitates an encapsulation of the TCP/IPv4 packet to a PPPoE frame prior to sending data to the WAN access driver 24.

The WAN access driver 24 receives packets from the WAN interface 30 and sends the packets to the multi-protocol driver 32. The packets sent to the multi-protocol driver 32 are then sent to the ISP 20 via a LAN interface 38.

The second IP application 36(2) may be a web browser or any other application that requests access to the Internet. Although only one second IP application 36(2) is shown to interface with the second IP protocol stack 28(2), multiple second IP applications 36(2) may interface with the first IP protocol stack 28(2).

The second protocol stack 28(s) provides TCP processing for IPv6 (TCP/IPv6). The second protocol stack 28(2) converts the data communicated from the second IP application 36(2) to TCP/IPv6 packets and sends the packets to the converter 23.

In the exemplary embodiment, the converter 23 facilitates an encapsulation of TCP/IPv6 frame to a PPPoE frame, and a sending of the frame to the multi-protocol driver 32. The PPP frame size should be less than or equal to the smaller MRU value since the MRU value determines the size of the packet that may be sent over the communication link. Exceeding the MRU value would require the PPP packet to be divided so that each divided packet did not exceed the MRU value. This may add additional overhead to the converter 23 to handle packet division. Therefore, it is advantageous to set the MTU value in the second protocol stack 28(2) such that the packets to be sent to the ISP 20 do not exceed the MRU value to prevent packet division. The converter 23 may also handle Neighbor Discovery packets for IPv6 (NDv6) as described in further detail below.

The packet sent to the multi-protocol driver 32 is sent to the ISP 20 via a Local Area Network (LAN) interface 38.

In addition to sending packets to the ISP 20, the data processing system 12 receives PPPoE packets from the ISP 20. A packet received from the ISP 20 is sent to the multi-protocol driver 32 via the LAN interface 38.

In one embodiment, the multi-protocol driver 32 sends the packet to the WAN access driver 24. If the WAN access driver 24 determines that the packet includes the correct protocol, IPv4, it sends the packet to the WAN interface 30 and informs the multi-protocol driver 32 that the WAN interface 30 accepted the packet. If however, the WAN access driver 24 determines that the packet is not the correct protocol, it informs the multi-protocol driver 32 that the WAN interface 30 rejected the packet, and the packet is sent to the converter 23 for processing.

In another embodiment, the multi-protocol driver 32 sends the packets to the converter 23. If the converter 23 determines that the packet is the correct protocol, IPv6, it accepts the packet by sending the packet to the second protocol stack 28(2) and informs the multi-protocol driver 32 that the converter 23 accepted the packet. If however, the converter 23 determines that the packet is not the correct protocol, it informs the multi-protocol driver 32 that the converter 23 rejected the packet, and the packet is sent to the WAN access driver 24 for processing.

In yet another embodiment, the multi-protocol driver 32 broadcasts the packets to the WAN access driver 24 and the converter 23. The WAN access driver 24 and the converter determine if they should accept or reject the packet. Alternatively, the packet may be sent from the LAN interface 38 directly to the WAN access driver 24 and the converter 23 without using the multi-protocol driver 32.

As would be understood by those skilled in the art, other methods exist for routing the packet to the correct stack. Any suitable method for routing the packet to the correct stack may be used.

If the WAN interface 30 accepts the packet, the packet is converted from a PPPoE packet to a TCP/IPv4 packet and sent to the first protocol stack 28(1). The first protocol stack 28(1) further processes the packet and provides data to the first IP Application 36(1).

If the converter 23 accepts the packet, the converter 23 converts the packet from a PPPoE to a TCP/IPv6 packet and is sent to the second protocol stack 28(2). The second protocol stack 28(2) further processes the packet and provides data to the second IP Application 36(2).

In one embodiment of the present invention, the converter 23 handles NDv6 packets from the second protocol stack 28(2). NDv6 defines Internet Control Message Protocol (ICMP) packet types including neighbor solicitation, neighbor advertisement, router solicitation, and router advertisement. When the converter 23 receives a neighbor solicitation from the second protocol stack 28(2), the converter 23 responds with a neighbor advertisement. The converter 23 responds to a router solicitation from the second protocol stack 28(2) by sending a router advertisement, the router advertisement includes the MRU so that the MTU may be configured. The converter 23 discards both neighbor advertisement and router advertisement sent by second protocol stack 28(2).

In another embodiment, when the converter 23 receives a router solicitation from the second protocol stack 28(2), the converter 23 modifies the router solicitation to remove Ethernet specific information and sends the router solicitation as a PPPv6 frame to the aggregator 18.

We claim:

1. A method of establishing a point-to-point link between a data processing system and an Internet Service Provider (ISP) and of configuring a first and second network-layer protocol for use over the link, the data processing system having a dialer, and a first and second protocol stack, the method comprising:
monitoring, by an access unit, the establishment of the link connection to determine a negotiated value;
monitoring, by the access unit, the first network-layer protocol configuration for the completion of the configuration; and
configuring, by the access unit, the link for the second network-layer protocol after the completion of the first-network layer protocol configuration.

2. The method of claim 1, further comprising receiving a router solicitation from the second protocol stack and responding to the second protocol stack with a router advertisement second protocol stack

3. The method of claim 1, wherein the first network-layer protocol is Internet Protocol version 4 (IPv4) and the second network-layer protocol is Internet Protocol version 6 (IPv6).

4. The method of claim 1, wherein the negotiated value is a maximum receive unit that is used to establish a maximum transmission unit for the second network-layer protocol.

5. The method of claim 4, wherein the maximum transmission unit for the second network-layer protocol is less than or equal to the maximum receive unit.

6. A method of communication between an Internet Service Provider (ISP) and a data processing system, the data processing system having a first protocol stack handling a first network-layer protocol, and second protocol stack handling a second network-layer protocol, the method comprising:
receiving a first packet the having a first network-layer protocol packet encapsulated in a data-link-layer protocol;
routing the first packet toward a Wide Area Network (WAN) interface;
receiving a second packet having a second network-layer protocol packet encapsulated in the data-link-layer protocol; and
converting the second packet to remove the data-link-layer protocol and sending the converted packet to the second protocol stack.

7. The method of claim 6, wherein the first network-layer protocol is IPv4 and the second network-layer protocol is IPv6.

8. The method of claim 6, wherein the data-link-layer protocol uses Ethernet to provide a PPPoE.

9. The method of claim 6, further comprises receiving a neighbor solicitation from the second protocol stack, and responding to the second protocol stack with a neighbor advertisement.

10. The method of claim 6, further comprises receiving a router solicitation from the second protocol stack and responding to the second protocol stack with a router advertisement, the router advertisement includes a maximum receive unit so that a maximum transfer unit may be configured.

11. The method of claim 10, wherein the maximum transfer unit is equal to the maximum receive unit.

12. The method of claim 6, further comprises discarding a neighbor advertisement received from the second protocol stack.

13. The method of claim 6, further comprises discarding a router advertisement received from the second protocol stack.

14. The method of claim 6, further comprises receiving a router solicitation from the second protocol stack, modifying the router solicitation to remove a data-link-layer information, and sending the modified router solicitation toward the ISP.

15. An access unit for configuring a first and second network-layer protocol for use over the point-to-point link and to facilitate communication between an Internet Service Provider (ISP) and a data processing system over the link, the data processing system including a first and second protocol stack, the access unit comprising:
a multi-protocol driver for routing a packet received from the ISP;
a Wide Area Network (WAN) access driver adapted to monitor an establishment of the link connection to capture a maximum receive unit; and
a converter adapted to receive a trigger from the WAN access driver, the trigger for indicating to the converter to configure the second network-layer protocol on the link.

16. The access unit of claim 15, wherein the trigger occurs after completing the network-layer protocol phase for the first network-layer protocol.

17. The access unit of claim The access unit of claim 15, wherein the WAN access driver is further adapted to accept the routed packet if it includes the first network-layer protocol and reject the routed packet if it include the second network-layer protocol, the WAN access driver adapted to forward the accepted packet toward a WAN interface.

18. The access unit of claim 17, wherein the converter is further adapted to convert the rejected packet to an second network-layer protocol packet and to send the converted packet toward the second protocol stack,

19. The access unit of claim 15, wherein the converter is further adapted to encapsulated a second network-layer protocol packet received from the second protocol stack into a Point-to-Point over Ethernet (PPPoE) packet and to send the PPPoE packet toward the ISP.

20. The access unit of claim 15, wherein the WAN access driver adapted to provide the maximum receive unit to the converter to configure a maximum transmission unit.

21. The access unit of claim 15, wherein the converter receives a neighbor solicitation from the second protocol stack and responds to the protocol stack the neighbor with a neighbor advertisement.

22. The access unit of claim 15, wherein the converter receives a router solicitation from the protocol stack and responds to the protocol stack with a router advertisement.
